(19) United States
(12) Patent Application Publication
(10) Pub. No.: US 2011/0141289 A1
(43) Pub. Date: Jun. 16, 2011

(54) METHOD AND SYSTEM FOR ASSESSING QUALITY OF MULTI-LEVEL VIDEO

(75) Inventors: Kyung Hee LEE, Daejeon (KR); Hyun Woo LEE, Daejeon (KR); Kyeong Seob CHO, Daejeon (KR); Sungkuen LEE, Seoul (KR); Won RYU, Daejeon (KR); Donggyu SIM, Seoul (KR); Seonoh LEE, Uijeongbu-si (KR)

(73) Assignee: Electronics and Telecommunications Research Institute, Daejeon (KR)

(21) Appl. No.: 12/963,243

(22) Filed: Dec. 8, 2010

(30) Foreign Application Priority Data
Dec. 16, 2009 (KR) 10-2009-0125386

(51) Int. Cl. H04N 17/00

(52) U.S. Cl. 348/180; 348/E17.001

(57) ABSTRACT

Provided is a method of assessing an image quality of each of a base layer and an enhanced layer using a different scheme to assess a quality of a multi-level video based on assessment results. A multi-level video quality assessing system includes: a bitstream extractor to separate a multi-level video into a base layer bitstream and an enhanced layer bitstream; a base layer quality assessment module to generate quality assessment result information of a base layer image by assessing an image quality of base layer bitstream; an enhanced layer quality assessment module to generate quality assessment result information of an enhanced layer image by assessing an image quality of enhanced layer bitstream; and a final video quality assessment module to assess a quality of experience (QoE) of multi-level video based on quality assessment result information of each of the base layer image and the enhanced layer image.

### CROSS-REFERENCE TO RELATED APPLICATION

This application claims the benefit of Korean Patent Application No. 10-2009-0125386, filed on Dec. 16, 2009, in the Korean Intellectual Property Office, the disclosure of which is incorporated herein by reference.

### BACKGROUND

1. Field of the Invention

The present invention relates to a method of assessing a quality of media image generated, transferred, and played according to a multi-level media compression scheme including a Scalable Video Coding (SVC) scheme, which is a Moving Picture Experts Group (MPEG)-21 Part13 standard. More particularly, the present invention relates to a method that may assess an image quality of each of a base layer and an enhanced layer using a different scheme and assess a quality of a multi-level video based on an assessment result, and thereby may provide an excellent performance in aspects of a calculation complexity and a processing rate.

2. Description of the Related Art

A video consisting of a plurality of layers, that is, a multi-level video may use a one-source and multi-use function of providing the same content by dynamically combining the layers depending on a network situation and thus is generally used for a multimedia transmission service.

To provide a function of dynamically configuring an image having a quality most suitable for a performance of a terminal or a communication environment in the multimedia transmission service, there is a need to assess and assess in real time the quality of the image provided to the terminal via a network, and thereby to support a server to determine a layer combination of the video to be transmitted.

In the convention art, schemes using only a quality of an image has been used as a quality assessment scheme of the image.

However, when applying the quality assessment scheme to each of layers constituting the image, it may increase a calculation complexity.

When performing a quality assessment with respect to only a final video where all the layers are integrated, it may be impossible to recognize an error and a quality change that may variously occur for each layer.

Accordingly, there is a need for an image quality assessment method that may accurately detect a change in an image quality of each media layer based on a structural characteristic of a multi-level media and a limited calculation capability of a terminal receiving media, and may also be readily applicable to the terminal.

### SUMMARY

An aspect of the present invention provides a system of assessing a quality of a multi-level video that may decrease a calculation complexity and quickly detect a quality change differently occurring in each layer of a media stream by directly assessing an image quality of a base layer with respect to a reconstructed image, by assessing an image quality of an enhanced layer using a decoding parameter for image reconstruction, and by assessing a final video quality based on a quality assessment result of each layer.

According to an aspect of the present invention, there is provided a system of assessing a quality of a multi-level video, including: a bitstream extractor to separate the multi-level video into a base layer bitstream and an enhanced layer bitstream; a base layer quality assessment module to generate quality assessment result information of a base layer image by assessing an image quality of the base layer bitstream; an enhanced layer quality assessment module to generate quality assessment result information of an enhanced layer image by assessing an image quality of the enhanced layer bitstream; and a final video quality assessment module to assess a quality of experience (QoE) of the multi-level video based on quality assessment result information of the base layer image and quality assessment result information of the enhanced layer image.

The enhanced layer quality assessment module may include: an enhanced layer analysis module to separate the enhanced layer bitstream into the plurality of bitstream units, and to verify a type of bitstream units and a number of bitstream units used for reconstructing the multi-level video; a parameter extraction module to extract, from each of the bitstream units, at least one decoding parameter associated with the image quality of the enhanced layer bitstream; and a quality assessment module to generate quality assessment result information of the enhanced layer image by assessing a quality of the enhanced layer image corresponding to the enhanced layer bitstream based on the decoding parameter.

The final video quality assessment module may include: an adaptation function selection module to select an adaptation function to be used for an image quality assessment based on the type of bitstream units and the number of bitstream units; and a final video quality assessment output module to output a QoE assessment result of the multi-level video by applying the selected adaptation function to quality assessment result information of the base layer image and quality assessment result information of the enhanced layer image.

According to another aspect of the present invention, there is provided a method of assessing a quality of a multi-level video, including: separating the multi-level video into a base layer bitstream and an enhanced layer bitstream; generating quality assessment result information of a base layer image by assessing an image quality of the base layer bitstream; generating quality assessment result information of an enhanced layer image by assessing an image quality of the enhanced layer bitstream using a scheme different from the base layer bitstream; and assessing a QoE of the multi-level video based on quality assessment result information of the base layer image and quality assessment result information of the enhanced layer image.

### EFFECT

According to embodiments of the present invention, there is provided a system of assessing a quality of a multi-level video that may decrease a calculation complexity and quickly detect a quality change differently occurring in each layer of a media stream by directly assessing an image quality of a base layer with respect to a reconstructed image, by assessing an image quality of an enhanced layer using a decoding parameter for image reconstruction, and by assessing a final video quality based on a quality assessment result of each layer.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a block diagram illustrating an example of a system of assessing a quality of a multi-level video according to an embodiment of the present invention;

FIG. 2 is a diagram illustrating a structure of a multi-level video according to an embodiment of the present invention;

FIG. 3 is a block diagram illustrating an example of a base layer quality assessment module of FIG. 1;

FIG. 4 is a block diagram illustrating an example of an enhanced layer quality assessment module of FIG. 1;

FIG. 5 is a block diagram illustrating an example of a final video quality assessment module of FIG. 1; and

FIG. 6 is a flowchart illustrating a method of assessing a quality of a multi-level video according to an embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

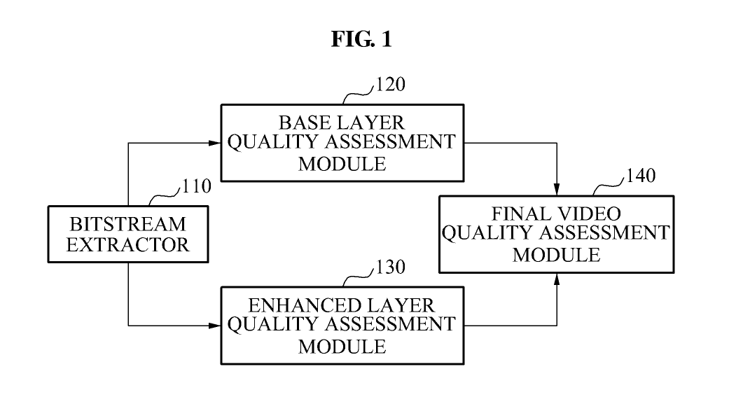

FIG. 1 is a block diagram illustrating an example of a system of assessing a quality of a multi-level video according to an embodiment of the present invention.

Referring to FIG. 1, the multi-level video quality assessing system may include a bitstream extractor 110, a base layer quality assessment module 120, an enhanced layer quality assessment module 130, and a final video quality assessment module 140.

The bitstream extractor 110 may receive the multi-level video and separate the multi-level video into a base layer bitstream and an enhanced layer bitstream.

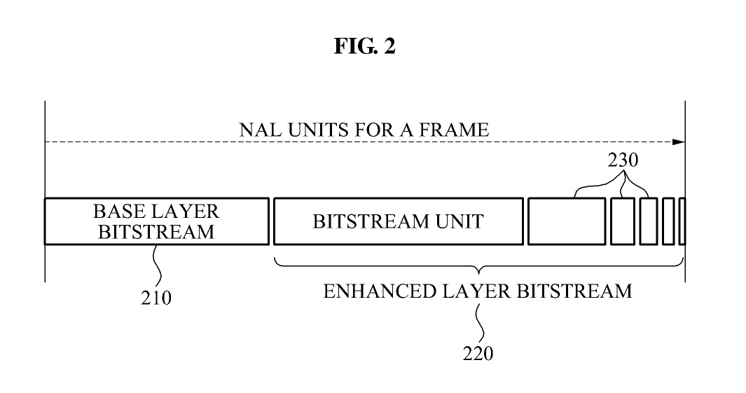

In this instance, as shown in FIG. 2, the multi-level video received by the bitstream extractor 110 may include a base layer bitstream 210 containing compression information associated with a base layer image, and an enhanced layer bitstream 220 containing compression information associated with an enhanced layer image. The enhanced layer bitstream 220 may include a plurality of bitstream units 230 to provide various levels of quality scalability.

The base layer quality assessment module 120 may generate quality assessment result information of the base layer image by assessing an image quality of the base layer bitstream separated by the bitstream extractor 110.

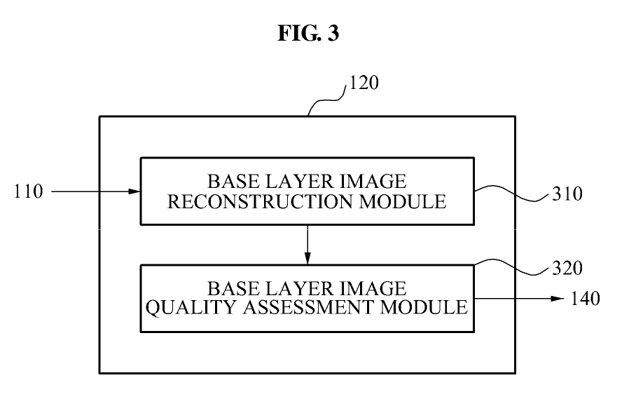

A configuration and an operation of the base layer quality assessment module 120 will be further described with reference to FIG. 3.

The enhanced layer quality assessment module 130 may generate quality assessment result information of the enhanced layer image by assessing an image quality of the enhanced layer bitstream separated by the bitstream extractor 110.

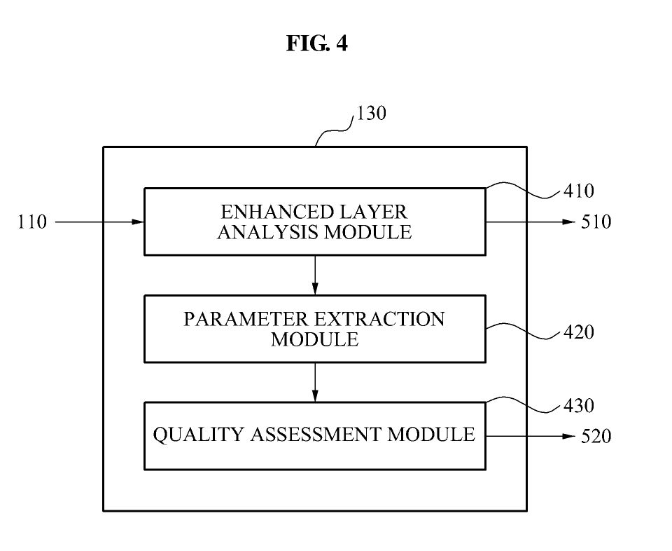

A configuration and an operation of the enhanced layer quality assessment module 130 will be further described with reference to FIG. 4.

The final video quality assessment module 140 may assess a quality of experience (QoE) of the multi-level video based on quality assessment result information of the base layer image generated by the base layer quality assessment module 120 and quality assessment result information of the enhanced layer image generated by the enhanced layer quality assessment module 130.

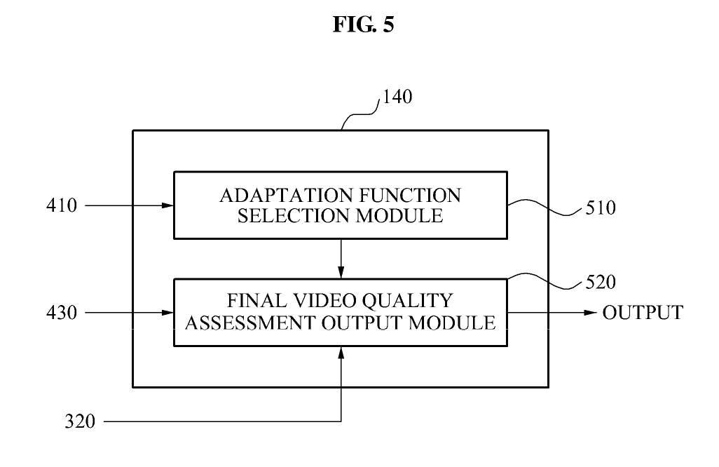

A configuration and an operation of the final video quality assessment module 140 will be further described with reference to FIG. 5.

FIG. 3 is a block diagram illustrating an example of the base layer quality assessment module 120 of FIG. 1.

As shown in FIG. 3, the base layer quality assessment module 120 may include a base layer image reconstruction module 310 and a base layer image quality assessment module 320.

The base layer image reconstruction module 310 may reconstruct a base layer image corresponding to the base layer bitstream using the base layer bitstream separated by the bitstream extractor 110, and may transmit the reconstructed base layer image to the base layer image quality assessment module 320. In this instance, the base layer quality assessment module 120 may not include the base layer image reconstruction module 310 and thus may receive a reconstructed base layer image from an apparatus having an image reconstruction as a major function such as a media player and then transmit the received reconstructed base layer image to the base layer image quality assessment module 320.

The base layer image quality assessment module 320 may generate quality assessment result information of the base layer image by assessing a quality of the base layer image.

In this instance, the base layer image quality assessment module 320 may assess the quality of the base layer image using one of a full-reference quality assessment scheme capable of using all of source image information prior to compressing or transmitting a reconstructed image, a reduced-referenced quality assessment scheme capable of using partial characteristic information extracted from a source image, and a non-reference quality assessment scheme of not using the source image information.

FIG. 4 is a block diagram illustrating an example of the enhanced layer quality assessment module 130 of FIG. 1.

As shown in FIG. 4, the enhanced layer quality assessment module 130 may include an enhanced layer analysis module 410, a parameter extraction module 420, a quality assessment module 430.

The enhanced layer analysis module 410 may separate the enhanced layer bitstream separated by the bitstream extractor 110 into a plurality of bitstream units, and transmit the separated bitstream units to the parameter extraction module 420.

Also, the enhanced layer analysis module 410 may verify a type of bitstream units and a number of bitstream units used for reconstructing the multi-level video, and transmit the verified type and number of bitstream units to an adaptation function selection module 510 of the final video quality assessment module 140.

The parameter extraction module 420 may extract, from each of the bitstream units received from the enhanced layer analysis module 410, at least one decoding parameter associated with the image quality of the enhanced layer bitstream.

For example, when the multi-level video corresponds to an H.264/Scalable Video Coding (SVC) video including, in the enhanced layer bitstream, a spatial enhanced bitstream unit, a quality enhanced bitstream unit, and a time enhanced bitstream unit, the parameter extraction module 420 may extract at least one decoding parameter from parameters such as a resolution of the enhanced layer image from the spatial enhanced bitstream unit, a reference level of image information of the base layer for reconstruction (Intra-BL Mode and MVD), and a residual energy of a differential signal of the enhanced layer generated based on a differential signal of the base layer.

Also, the parameter extraction module 420 may extract, as the decoding parameter, at least one of a magnitude difference between quantization parameters from the quality enhanced bitstream unit, and a magnitude of the differential signal of the enhanced layer generated based on the differential signal of the base layer.

The quality assessment module 430 may generate quality assessment result information of the enhanced layer image by assessing a quality of the enhanced layer image corresponding to the enhanced layer bitstream based on the decoding parameter extracted by the parameter extraction module 420.

For example, the quality assessment module 430 may generate quality assessment result information of the enhanced layer image by applying, to the decoding parameter extracted from the spatial enhanced bitstream unit, the following Equation 1:

$$VQM\_enhance = ( \frac{f ( RE\_SP ) + g ( MVD\_A )}{h ( Intra\_BL \_R )} ) , \\ if\_there \_is \_no \_value \to RE\_SP , MVD\_A = 0 , \\ Intra\_BL \_R = 1 \qquad [ Equation 1 ]$$

Here, Intra_BL_R denotes a ratio of a block using image information of the base layer to predict a signal of the enhanced layer with respect to the entire image, and MVD_A denotes a differential value of a motion vector of the enhanced layer generated based on a motion vector of the base layer.

Also, RE_SP denotes the residual energy of the differential signal of the enhanced layer generated based on the differential signal of the base layer. In this instance, RE_SP may be calculated according to Equation 2:

$$RE\_SP = {\sum }_{i}^{row} {\sum }_{j}^{col} \frac{{R ( i , j )}^{2}}{{255}^{2}} \qquad [ Equation 2 ]$$

Here, R(i, j) denotes a magnitude of a differential signal corresponding to a pixel (i, j), row denotes a vertical length of an image resolution, and col denotes a horizontal length of the image resolution.

Also, although Equation 2 calculates an RE_SP value in a spatial area, the same result may be obtained by calculating the RE_SP value in a frequency domain.

As another example, the quality assessment module 430 may generate quality assessment result information of the enhanced layer image by applying, to the decoding parameter extracted from the quality enhanced bitstream unit, the following Equation 3:

VQM_enhance=f(g(QP_{—}R),h(RE_{—}SN)),if_there_is_no_value→RE_{—}SN,QP_{—}R=0 [Equation 3]

Here, QP_R denotes a difference value between a quantization parameter of the base layer and a quantization parameter of the enhanced layer, and RN_SN denotes a residual energy of the differential signal of the enhanced layer generated based on the differential signal of the base layer. In this instance, RE_SN may be calculated using Equation 2.

FIG. 5 is a block diagram illustrating an example of the final video quality assessment module 140 of FIG. 1.

As shown in FIG. 5, the final video quality assessment module 140 may include the adaption function selection module 510 and a final video quality assessment output module 520.

The adaption function selection module 510 may select an adaptation function to be used for an image quality assessment based on the type of bitstream units and the number of bitstream units.

The final video quality assessment output module 520 may output a QoE assessment result of the multi-level video by applying the selected adaptation function to quality assessment result information of the base layer image transmitted from the base layer image quality assessment module 320, and quality assessment result information of the enhanced layer image transmitted from the quality assessment module 510.

For example, the final video quality assessment output module 520 may calculate a QoE assessment result VQM by applying, to quality assessment result information of the base layer image VQM_base and quality assessment result information of the enhanced layer image VQM_enhance, the following Equation 4:

VQM=α×(VQM_base+β)×(VQM_enhance+δ)

Here, each of α, β, and δ denotes a constant, and may be variously applicable depending on which layer image quality result may be assigned with a weight.

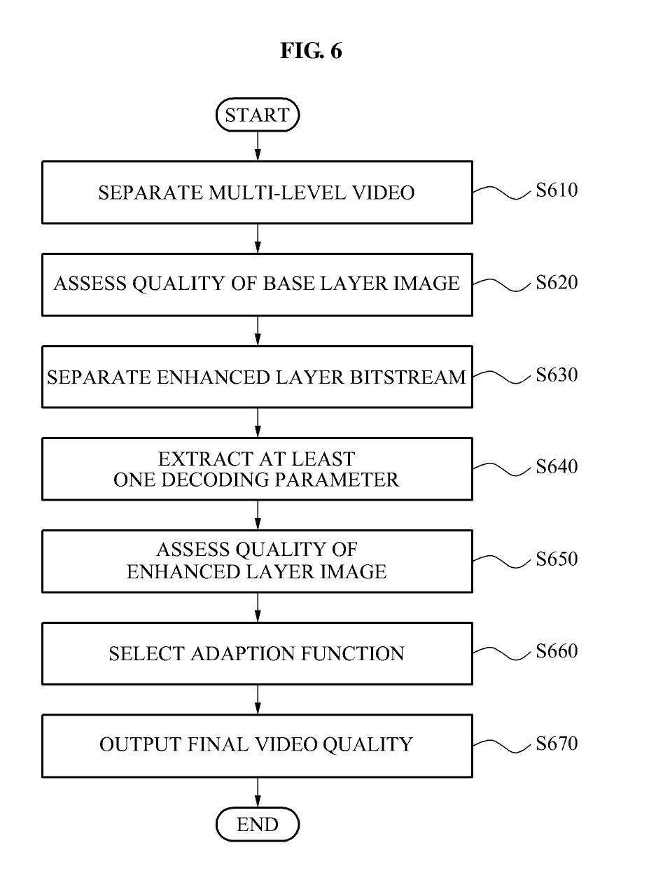

FIG. 6 is a flowchart illustrating a method of assessing a quality of a multi-level video according to an embodiment of the present invention.

In operation S610, the bitstream extractor 110 may receive the multi-level video and separate the multi-level video into a base layer bitstream and an enhanced layer bitstream.

In operation S620, the enhanced layer quality assessment module 130 may generate quality assessment result information of the enhanced layer image by assessing an image quality of the enhanced layer bitstream separated in operation S610.

In operation S630, the enhanced layer analysis module 410 may separate the separated enhanced layer bitstream into a plurality of bitstream units, and verify a type of bitstream units and a number of bitstream units used for reconstructing the multi-level video.

In operation S640, the parameter extraction module 420 may extract, from each of the bitstream units, at least one decoding parameter associated with the image quality of the enhanced layer bitstream.

In operation S650, the quality assessment module 430 may generate quality assessment result information of the enhanced layer image by assessing a quality of the enhanced layer image corresponding to the enhanced layer bitstream based on the extracted decoding parameter.

In this instance, operations S630, S640, and S650 may be performed with operation S620 in parallel or orders thereof may be changed and thereby be performed.

In operation S660, the adaption function selection module 510 may select an adaptation function to be used for an image quality assessment based on the type of bitstream units and the number of bitstream units.

In operation S670, the final video quality assessment output module 520 may output a QoE assessment result of the multi-level video by applying the selected adaptation function to quality assessment result information of the base layer image generated in operation S620, and the quality assessment result information of the enhanced layer image generated in operation S650.

According to embodiments of the present invention, a system of assessing a quality of a multi-level video may decrease a calculation complexity and quickly detect a quality change differently occurring in each layer of a media stream by directly assessing an image quality of a base layer with respect to a reconstructed image, by assessing an image quality of an enhanced layer using a decoding parameter for image reconstruction, and by assessing a final video quality based on a quality assessment result of each layer.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A system of assessing a quality of a multi-level video, comprising:
a bitstream extractor to separate the multi-level video into a base layer bitstream and an enhanced layer bitstream;
a base layer quality assessment module to generate quality assessment result information of a base layer image by assessing an image quality of the base layer bitstream;
an enhanced layer quality assessment module to generate quality assessment result information of an enhanced layer image by assessing an image quality of the enhanced layer bitstream; and
a final video quality assessment module to assess a quality of experience (QoE) of the multi-level video based on quality assessment result information of the base layer image and quality assessment result information of the enhanced layer image.

2. The system of claim 1, wherein the enhanced layer bitstream includes a plurality of bitstream units.

3. The system of claim 2, wherein the enhanced layer quality assessment module comprises:
an enhanced layer analysis module to separate the enhanced layer bitstream into the plurality of bitstream units, and to verify a type of bitstream units and a number of bitstream units used for reconstructing the multi-level video;
a parameter extraction module to extract, from each of the bitstream units, at least one decoding parameter associated with the image quality of the enhanced layer bitstream; and
a quality assessment module to generate quality assessment result information of the enhanced layer image by assessing a quality of the enhanced layer image corresponding to the enhanced layer bitstream based on the decoding parameter.

4. The system of claim 3, wherein when the bitstream unit corresponds to a spatial enhanced bitstream unit, the parameter extraction module extracts, as the decoding parameter, at least one of a resolution of an enhanced layer image, a reference level of image information of a base layer for reconstruction, and a magnitude of a differential signal of the enhanced layer generated based on a differential signal of the base layer.

5. The system of claim 3, wherein when the bitstream unit corresponds to a quality enhanced bitstream unit, the parameter extraction module extracts, as the decoding parameter, at least one of a magnitude difference between quantization parameters and a magnitude of a differential signal of an enhanced layer generated based on a differential signal of a base layer.

6. The system of claim 3, wherein the final video quality assessment module comprises:
an adaptation function selection module to select an adaptation function to be used for an image quality assessment based on the type of bitstream units and the number of bitstream units; and
a final video quality assessment output module to output a QoE assessment result of the multi-level video by applying the selected adaptation function to quality assessment result information of the base layer image and quality assessment result information of the enhanced layer image.

7. The system of claim 1, wherein the base layer quality assessment module comprises:
a base layer image reconstruction module to reconstruct a base layer image corresponding to the base layer bitstream using the base layer bitstream; and
a base layer image quality assessment module to generate quality assessment result information of the base layer image by assessing a quality of the base layer image.

8. The system of claim 7, wherein the base layer image quality assessment module assesses the quality of the base layer image using one of a full-reference quality assessment scheme, a reduced-reference quality assessment scheme, and a non-reference quality assessment scheme.

9. A method of assessing a quality of a multi-level video, comprising:
separating the multi-level video into a base layer bitstream and an enhanced layer bitstream;
generating quality assessment result information of a base layer image by assessing an image quality of the base layer bitstream;
generating quality assessment result information of an enhanced layer image by assessing an image quality of the enhanced layer bitstream using a scheme different from the base layer bitstream; and
assessing a QoE of the multi-level video based on quality assessment result information of the base layer image and quality assessment result information of the enhanced layer image.

10. The method of claim 9, wherein the enhanced layer bitstream includes a plurality of bitstream units.

11. The method of claim 10, wherein the generating of the quality assessment result information of the enhanced layer image comprises:
separating the enhanced layer bitstream into the plurality of bitstream units;
verifying a type of bitstream units and a number of bitstream units used for reconstructing the multi-level video in the enhanced layer bitstream;
extracting, from each of the bitstream units, at least one decoding parameter associated with the image quality of the enhanced layer bitstream; and
generating quality assessment result information of the enhanced layer image by assessing a quality of the enhanced layer image corresponding to the enhanced layer bitstream based on the decoding parameter.

12. The method of claim 11, wherein when the bitstream unit corresponds to a spatial enhanced bitstream unit, the extracting comprises extracting, as the decoding parameter, at least one of a resolution of an enhanced layer image, a reference level of image information of a base layer for reconstruction, and a magnitude of a differential signal of the enhanced layer generated based on a differential signal of the base layer.

13. The method of claim 11, wherein when the bitstream unit corresponds to a quality enhanced bitstream unit, the extracting comprises extracting, as the decoding parameter, at least one of a magnitude difference between quantization parameters and a magnitude of a differential signal of an enhanced layer generated based on a differential signal of a base layer.

14. The method of claim 11, wherein the assessing comprises:
selecting a adaptation function to be used for an image quality assessment based on the type of bitstream units and the number of bitstream units; and
outputting a QoE assessment result of the multi-level video by applying the selected adaptation function to quality assessment result information of the base layer image and quality assessment result information of the enhanced layer image.

15. The method of claim 9, wherein the generating of the quality assessment result information of the base layer image comprises:
reconstructing a base layer image corresponding to the base layer bitstream using the base layer bitstream; and
generating quality assessment result information of the base layer image by assessing a quality of the base layer image.

16. The method of claim 15, wherein the generating of the quality assessment result information of the base layer image by assessing the quality of the base layer image comprises assessing the quality of the base layer image using one of a full-reference quality assessment scheme, a reduced-reference quality assessment scheme, and a non-reference quality assessment scheme.
